(19) United States
(12) Patent Application Publication
(10) Pub. No.: US 2025/0044633 A1
(43) Pub. Date: Feb. 6, 2025

(54) LIQUID CRYSTAL DISPLAY ELEMENT AND DISPLAY DEVICE

(71) Applicant: SONY GROUP CORPORATION, TOKYO (JP)

(72) Inventor: NOBUO IWASAKI, TOKYO (JP)

(21) Appl. No.: 18/718,078

(22) PCT Filed: Oct. 20, 2022
(86) PCT No.: PCT/JP2022/039085

§ 371 Date: Jun. 10, 2024

(30) Foreign Application Priority Data
Dec. 17, 2021 (JP) 2021-205013

(51) Int. Cl. G02F 1/1333; G02F 1/1337; G02F 1/1343

(52) U.S. Cl. CPC G02F 1/133388; G02F 1/1337; G02F 1/134309

(57) ABSTRACT

A liquid crystal display element according to the present disclosure includes: a first substrate; a second substrate disposed opposite to the first substrate, with a liquid crystal layer, including multiple liquid crystal molecules, interposed between the first and second substrates; a first electrode unit formed in an effective pixel region in the first substrate, and a peripheral region of the effective pixel region in the first substrate; a second electrode unit including a pixel electrode unit formed in the effective pixel region in the second substrate, and a peripheral driving electrode unit formed in the peripheral region in the second substrate; a first alignment film formed in the effective pixel region in each of the first and second substrates, with a direction of alignment taking a first angle of direction; and a second alignment film formed in the peripheral region in each of the first and second substrates, with a direction of alignment taking a second angle of direction differing by 45° from the first angle of direction.

### TECHNICAL FIELD

The present disclosure relates to a liquid crystal display element and a display apparatus.

### BACKGROUND ART

As for liquid crystal display elements, developments have been made of techniques of suppressing influences of ionic impurities flowing into a liquid crystal layer on display characteristics (for example, see PTLs 1 and 2). PTL 1 proposes a technique of generating a lateral electric field by applying a different driving voltage to between multiple electrodes provided in a peripheral region of an effective pixel region, to move impurity ions to outside the effective pixel region.

### CITATION LIST

### Patent Literature

PTL 1: Japanese Unexamined Patent Application Publication No. 2008-58497
PTL 2: Japanese Unexamined Patent Application Publication No. 2012-123144

### SUMMARY OF THE INVENTION

In the techniques mentioned above, it is conceivable that unnecessary light is generated in the peripheral region. In this case, the unnecessary light may be suppressed by providing, for example, a mechanical light shielding unit, but in this case, there is possibility that vignetting of light beams occurs in output light from the effective pixel region, resulting degradation in image quality.

It is desirable to provide a liquid crystal display element and a display apparatus that make it possible to suppress degradation in image quality and generation of unnecessary light.

A liquid crystal display element according to an embodiment of the present disclosure includes: a first substrate; a second substrate disposed opposite to the first substrate, with a liquid crystal layer, including multiple liquid crystal molecules, interposed between the first substrate and the second substrate; a first electrode unit formed in an effective pixel region in the first substrate, and a peripheral region of the effective pixel region in the first substrate; a second electrode unit including a pixel electrode unit and a peripheral driving electrode unit, the pixel electrode unit being formed in the effective pixel region in the second substrate, and the peripheral driving electrode unit being formed in the peripheral region in the second substrate; a first alignment film formed in the effective pixel region in each of the first substrate and the second substrate, with a direction of alignment taking a first angle of direction; and a second alignment film formed in the peripheral region in each of the first substrate and the second substrate, with a direction of alignment taking a second angle of direction, the second angle of direction differing by 45° from the first angle of direction.

A display apparatus according to an embodiment of the present disclosure is provided with a liquid crystal display element and a projection optical system that projects an image generated by the liquid crystal display element. The liquid crystal display element includes: a first substrate; a second substrate disposed opposite to the first substrate, with a liquid crystal layer, including multiple liquid crystal molecules, interposed between the first substrate and the second substrate; a first electrode unit formed in an effective pixel region in the first substrate, and a peripheral region of the effective pixel region in the first substrate; a second electrode unit including a pixel electrode unit and a peripheral driving electrode unit, the pixel electrode unit being formed in the effective pixel region in the second substrate, and the peripheral driving electrode unit being formed in the peripheral region in the second substrate; a first alignment film formed in the effective pixel region in each of the first substrate and the second substrate, with a direction of alignment taking a first angle of direction; and a second alignment film formed in the peripheral region in each of the first substrate and the second substrate, with a direction of alignment taking a second angle of direction, the second angle of direction differing by 45° from the first angle of direction.

In the liquid crystal display element or the display apparatus according to the embodiment of the present disclosure, the peripheral driving electrode unit is formed in the peripheral region of the effective pixel region, and the second alignment film is formed in the peripheral region. The second alignment film differs in the angle of direction by 45° from the first alignment film formed in the effective pixel region.

### BRIEF DESCRIPTION OF DRAWINGS

FIG. 1 is a cross-sectional view of a first configuration example of a liquid crystal display element according to a comparative example.

FIG. 2 is a cross-sectional view of a first configuration example of a liquid crystal display element according to a first embodiment of the disclosure.

FIG. 3 is a plan view of the first configuration example of the liquid crystal display element according to the first embodiment.

FIG. 4 is an explanatory diagram illustrating in outline a liquid crystal element of a luminance modulation type.

FIG. 5 is an explanatory diagram illustrating in outline a liquid crystal element of a phase modulation type.

FIG. 6 is a cross-sectional view of a second configuration example of the liquid crystal display element according to the comparative example.

FIG. 7 is a cross-sectional view of a second configuration example of the liquid crystal display element according to the first embodiment.

FIG. 8 is a plan view of a modification example 1 of the liquid crystal display element according to the first embodiment.

FIG. 9 is a cross-sectional view of a modification example 2 of the liquid crystal display element according to the first embodiment.

FIG. 10 is a cross-sectional view of a first configuration example of a display apparatus according to the first embodiment.

FIG. 11 is a cross-sectional view of a second configuration example of the display apparatus according to the first embodiment.

FIG. 12 is a cross-sectional view of a configuration example of a liquid crystal display element and a display apparatus according to a comparative example.

FIG. 13 is a cross-sectional view of a configuration example of a liquid crystal display element and a display apparatus according to a second embodiment.

### MODES FOR CARRYING OUT THE INVENTION

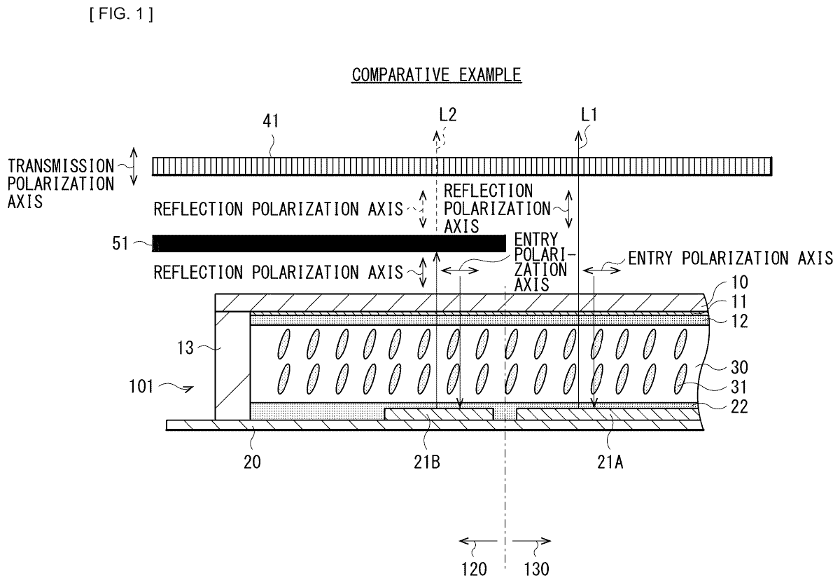

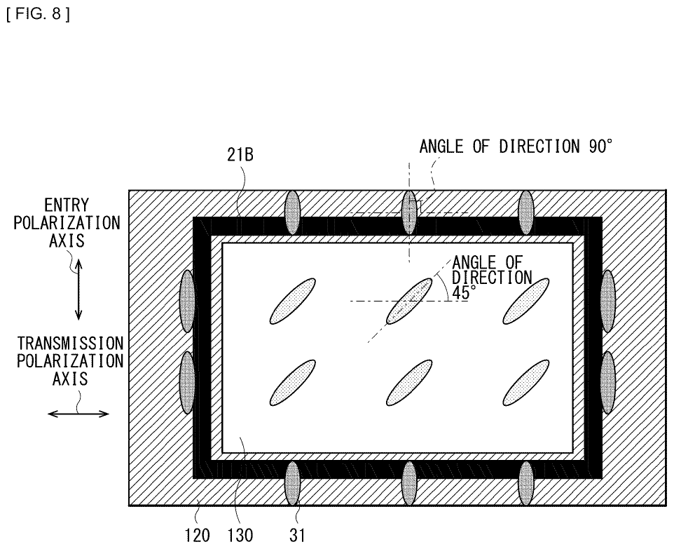

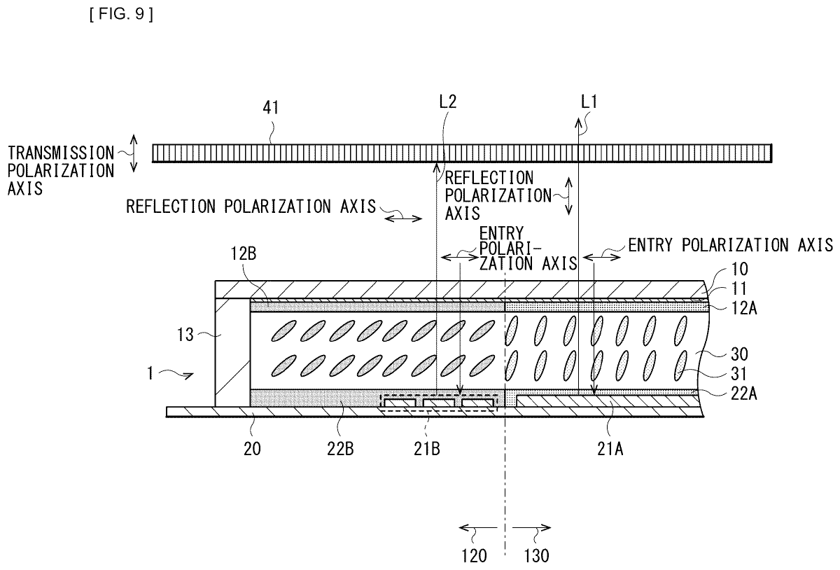

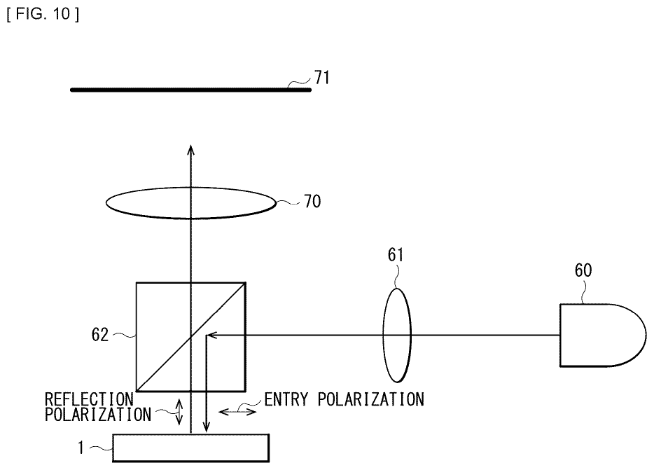

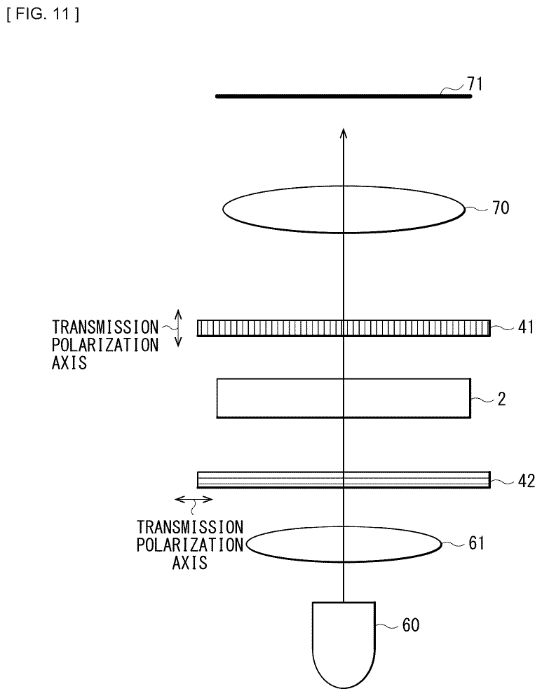

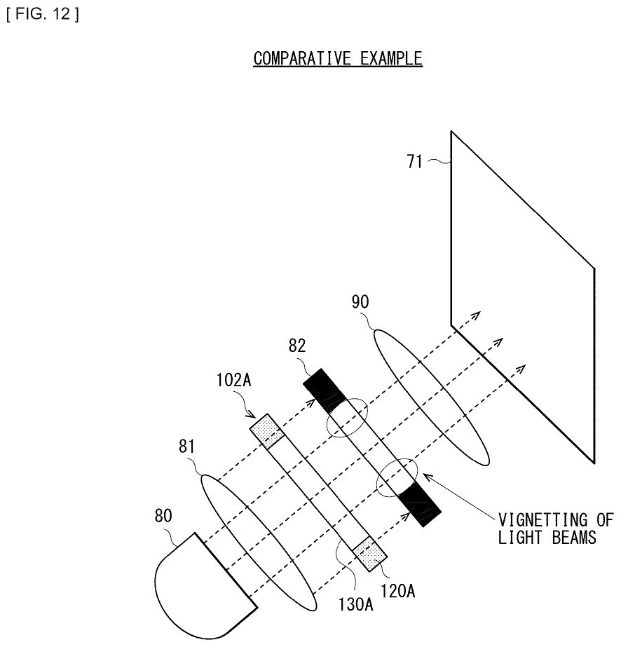

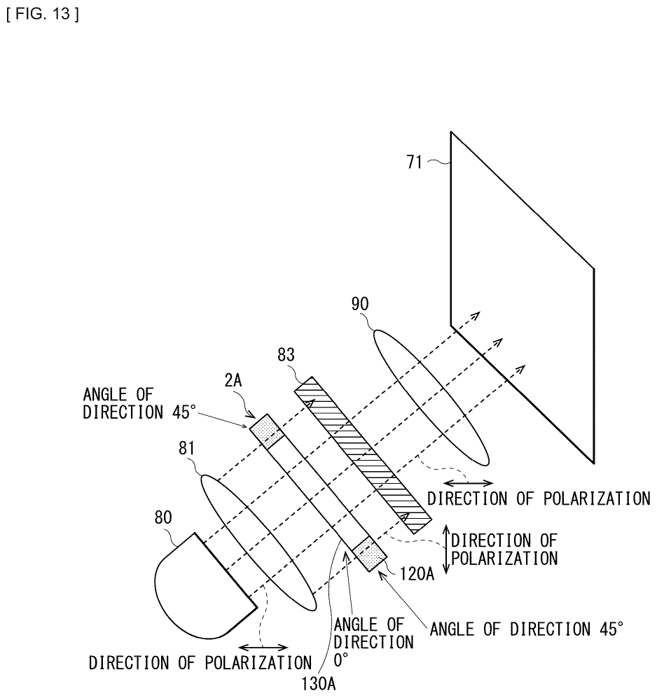

Some embodiments of the present disclosure are described below in detail with reference to the drawings. It is to be noted that description is given in the following order.
1. First Embodiment (Effective Pixel Region is Liquid Crystal Element of Luminance Modulation Type)
1.1 Configuration and Operation of Liquid Crystal Element (FIGS. 1 to 7)
1.2 Modulation Examples (FIGS. 8 and 9)
1.3 Application Examples to Display Apparatus (FIGS. 10 and 11)
1.4 Effects
2. Second Embodiment (Effective Pixel Region is Liquid Crystal Element of Phase Modulation Type) (FIGS. 12 and 13)
3. Other Embodiments

### 1. First Embodiment (Effective Pixel Region is Liquid Crystal Element of Luminance Modulation Type)

### 1.1 Configuration and Operation of Liquid Crystal Display Element

### Liquid Crystal Display Element According to Comparative Example

FIG. 1 illustrates an example of a cross-sectional configuration of a liquid crystal display element 101 according to a first configuration example of a comparative example.

As the first configuration example of the comparative example, a configuration example of a reflective liquid crystal display element is illustrated. This liquid crystal display element 101 is configured as a liquid crystal element of a luminance modulation type as a whole. The liquid crystal display element 101 includes a counter substrate 10 as a first substrate and a pixel substrate 20 as a second substrate. The pixel substrate 20 is disposed opposite to the counter substrate 10, with a liquid crystal layer 30 interposed between the counter substrate 10 and the pixel substrate 20. The liquid crystal layer 30 includes multiple liquid crystal molecules 31. A periphery of the counter substrate 10 and the pixel substrate 20 are bonded to each other by a sealing material 13.

The counter substrate 10 includes glass or an optically transparent material such as a transparent resin. In an effective pixel region 130 in the counter substrate 10 and a peripheral region 120 of the effective pixel region 130 in the counter substrate 10, a counter electrode unit 11 as a first electrode unit is formed over an entire surface. The counter electrode unit 11 is a common electrode formed of a transparent conductive film such as an ITO (Indium Tin Oxide) film. Moreover, in the counter substrate 10, in the effective pixel region 130 and the peripheral region 120, a single alignment film 12 is formed over an entire surface to cover the counter electrode unit 11. A direction of alignment of the alignment film 12 is, for example, a direction inclined by 45° with respect to a direction of polarization of entering light. The alignment film 12 includes, for example, a vapor-deposited film of an inorganic material, or an organic film obtained by rubbing treatment of an organic material such as polyimide.

It is to be noted that the effective pixel region 130 is, for example, a rectangular region in a plan view of the liquid crystal display element 101. The peripheral region 120 is a region that surrounds a periphery of the effective pixel region 130 of the rectangular shape, for example, in the plan view of the liquid crystal display element 101.

The pixel substrate 20 includes, for example, a TFT (Thin Film Transistor) substrate. In the effective pixel region 130 in the pixel substrate 20, a pixel electrode unit 21A is formed. The pixel electrode unit 21A includes, for example, multiple pixel electrodes arranged in a matrix. Moreover, in the peripheral region 120 of the effective pixel region 130 in the pixel substrate 20, a peripheral driving electrode unit 21B is formed. Moreover, in the pixel substrate 20, in the effective pixel region 130 and the peripheral region 120, a single alignment film 22 is formed over an entire surface to cover the pixel electrode unit 21A and the peripheral driving electrode unit 21B. A direction of alignment of the alignment film 22 is, for example, a direction inclined by 45° with respect to the direction of polarization of the entering light. The alignment film 22 includes, for example, a vapor-deposited film of an inorganic material, or an organic film obtained by rubbing treatment of an organic material such as polyimide.

The peripheral driving electrode unit 21B includes one electrode or multiple electrodes. For example, the peripheral driving electrode unit 21B is configured to generate a lateral electric field by applying a periodically switching driving voltage of a rectangular shape to between adjacent electrodes of the multiple electrodes, to move impurity ions to the peripheral region 120. In a case of a method in which the driving voltage of the rectangular shape is also applied to the pixel electrode unit 21A, a frequency of the driving voltage to be applied to the peripheral driving electrode unit 21B may be set higher than a frequency of the driving voltage to be applied to the pixel electrode unit 21A. Furthermore, magnitude (amplitude) of the driving voltage to be applied to the peripheral driving electrode unit 21B may be set larger than magnitude (amplitude) of the driving voltage to be applied to the pixel electrode unit 21A.

In the liquid crystal display element 101, in the effective pixel region 130, the entering light that has entered the counter substrate 10 is modulated by the liquid crystal layer 30, while being reflected by the pixel electrode unit 21A, and is outputted from the counter substrate 10 side. In the liquid crystal display element 101, reflected light of which a direction of polarization (reflection polarization axis) is orthogonal to the direction of polarization of the entering light (entry polarization axis) is outputted as output light L1 through an analyzer 41. The analyzer 41 is, for example, a polarizing plate having a predetermined transmission polarization axis. The transmission polarization axis of the analyzer 41 is configured to be in the same direction as the reflection polarization axis of the reflected light to be outputted from the liquid crystal display element 101.

In the liquid crystal display element 101, the alignment film 12 and the alignment film 22 are formed that have the same direction of alignment in the effective pixel region 130 and the peripheral region 120. Thus, in the peripheral region 120 as well, the entering light that has entered the counter substrate 10 is modulated by the liquid crystal layer 30, while being reflected by the peripheral driving electrode unit 21B, and is outputted from the counter substrate 10 side. That is, in the liquid crystal display element 101, in the peripheral region 120 as well, the reflected light of which the direction of polarization (reflection polarization axis) is orthogonal to the direction of polarization of the entering light (entry polarization axis) is outputted as output light L2 through the analyzer 41. The output light L2 in the peripheral region 120 becomes unnecessary light. In this case, it is conceivable to suppress the unnecessary light by providing, for example, a light shielding mask 51 as a mechanical light shielding unit. However, by providing the light shielding mask 51, it is conceivable that vignetting of light beams occurs in the output light L1 from the effective pixel region 130, resulting in degradation in image quality. Accordingly, in the configuration of the liquid crystal display element 101, it is difficult to suppress the vignetting of the output light L1 from the effective pixel region 130 while suppressing, by the peripheral driving electrode unit 21B, the degradation in the image quality to be caused by the impunty ions.

### Liquid Crystal Display Element According to First Embodiment

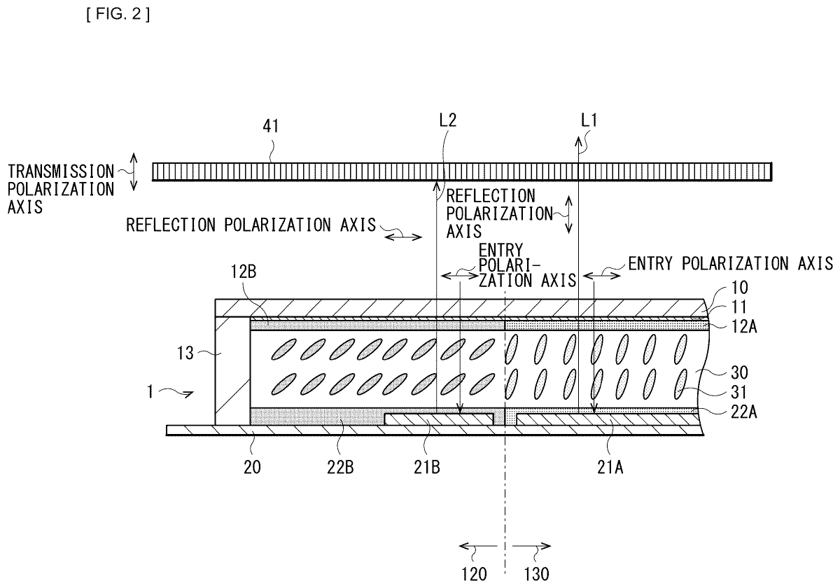

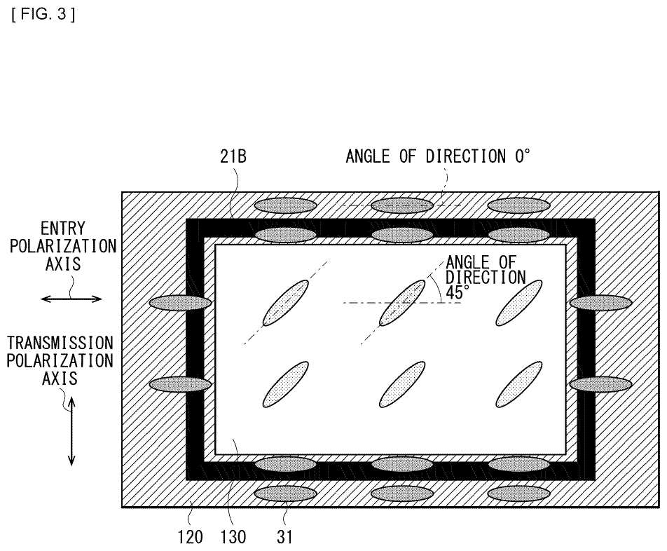

FIG. 2 illustrates an example of across-sectional configuration of a liquid crystal display element 1 according to a first configuration example of a first embodiment of the present disclosure. FIG. 3 illustrates an example of a plan configuration of the liquid crystal display element 1 according to the first configuration example of the first embodiment.

In the following, description is given of portions different from the liquid crystal display element 101 according to the comparative example illustrated in FIG. 1.

As the first configuration example of the first embodiment, a configuration example of a reflective liquid crystal display element is illustrated. In this liquid crystal display element 1, in the effective pixel region 130 in each of the counter substrate 10 and the pixel substrate 20, a first alignment film (an alignment film 12A and an alignment film 22A) is formed. The alignment film 12A is formed, in the counter substrate 10, to cover the counter electrode unit 11 in the effective pixel region 130. The alignment film 22A is formed, in the pixel substrate 20, to cover the pixel electrode unit 21A in the effective pixel region 130. A direction of alignment (first angle of direction) of the alignment film 12A and the alignment film 22A is, for example, a direction inclined by 45° with respect to the direction of polarization of the entering light. The alignment film 12 includes, for example, a vapor-deposited film of an inorganic material, or an organic film obtained by rubbing treatment of an organic material such as polyimide.

Moreover, in the liquid crystal display element 1, in the peripheral region 120 in each of the counter substrate 10 and the pixel substrate 20, a second alignment film (an alignment film 12B and an alignment film 22B) is formed. The alignment film 12B is formed, in the counter substrate 10, to cover the counter electrode unit 11 in the peripheral region 120. The alignment film 22B is formed, in the pixel substrate 20, to cover the peripheral driving electrode unit 21B in the peripheral region 120. A direction of alignment (second angle of direction) of the alignment film 12B and the alignment film 22B is configured to be a direction that differs by 45° from the direction of alignment (first angle of direction) of the alignment film 12A and the alignment film 22A. The direction of alignment (second angle of direction) of the alignment film 12B and the alignment film 22B is, for example, parallel to the direction of polarization of the entering light. Alternatively, the direction of alignment (second angle of direction) of the alignment film 12B and the alignment film 22B may be perpendicular to the direction of polarization of the entering light. The alignment film 12B and the alignment film 22B include, for example, a vapor-deposited film of an inorganic material, or an organic film obtained by rubbing treatment of an organic material such as polyimide.

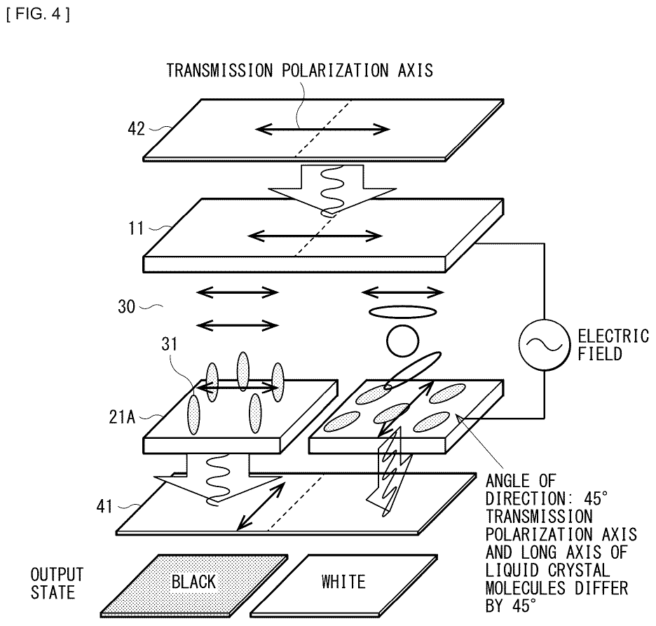

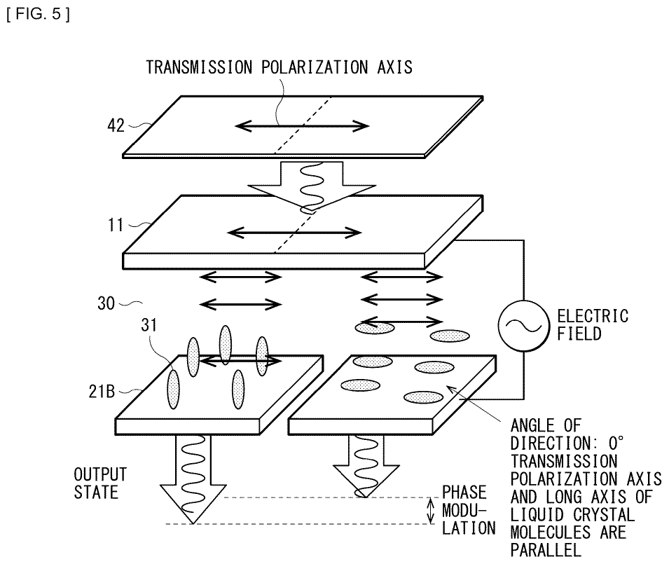

This liquid crystal display element 1 is configured to operate as a liquid crystal element of a luminance modulation type in the effective pixel region 130 and as a liquid crystal element of a phase modulation type (SLM (Spatial Light Modulator)) in the peripheral region 120. FIG. 4 illustrates in outline a liquid crystal element of the luminance modulation type. FIG. 5 illustrates in outline a liquid crystal element of the phase modulation type. FIGS. 4 and 5 illustrate a configuration example of a transmissive liquid crystal element for the sake of description.

In the liquid crystal element of the luminance modulation type, generally, a polarizer 42 including, for example, a polarizing plate is disposed in a direction of entry of light, and the analyzer 41 including, for example, a polarizing plate is disposed in a direction of output of light. The polarizer 42 has a predetermined transmission polarization axis and outputs polarized light polarized in a predetermined direction of polarization. In the liquid crystal element of the luminance modulation type, the direction of alignment of the liquid crystal molecules 31 of the liquid crystal layer 30 (the long axis of the liquid crystal molecules 31) is, for example, a direction inclined by 45° with respect to the transmission polarization axis of the polarizer 42 when viewed from the front, as illustrated in FIG. 4. An inclination in a cross-section of the liquid crystal molecules 31 changes with a voltage to be applied to the liquid crystal layer 30. This causes a polarization state of the modulated light to be outputted from the liquid crystal element of the luminance modulation type to change with the applied voltage. An amount of light to be finally outputted from the analyzer 41 changes with the polarization state of the modulated light.

For example, when the liquid crystal layer 30 is in anon-applied state, the liquid crystal molecules 31 are aligned substantially perpendicular to a substrate surface of the liquid crystal element. Polarized light of the linearly polarized light that has entered the liquid crystal layer 30 passes through the liquid crystal layer 30 with little influence of the liquid crystal molecules 31. Under a condition that the polarizer 42 and the analyzer 41 are in a crossed Nicol arrangement, a final light output state becomes black display.

Moreover, for example, when a predetermined voltage is applied to the liquid crystal layer 30, the liquid crystal molecules 31 are aligned substantially parallel to the substrate surface of the liquid crystal element. In this case, polarized light of the linearly polarized light that has entered the liquid crystal layer 30 becomes linearly polarized light rotated by 90° in the liquid crystal layer 30. Under the condition that the polarizer 42 and the analyzer 41 are in the crossed Nicol arrangement, the modulated light passes through the analyzer 41, and the final light output state becomes white display.

In the liquid crystal element of the phase modulation type, generally, the polarizer 42 including, for example, a polarizing plate is disposed in the direction of entry of light, and no analyzer 42 is disposed in the direction of output of light. In the liquid crystal element of the phase modulation type, the direction of alignment of the liquid crystal molecules 31 of the liquid crystal layer 30 (the long axis of the liquid crystal molecules 31) is, for example, parallel to the transmission polarization axis of the polarizer 42 when viewed from the front, as illustrated in FIG. 5. The inclination in the cross-section of the liquid crystal molecules 31 changes with the voltage to be applied to the liquid crystal layer 30. Thus, a phase state of the modulated light to be outputted from the liquid crystal element of the phase modulation type changes with the applied voltage.

In the liquid crystal element of the phase modulation type, only a phase of light changes by the inclination of the liquid crystal molecules 31, and the polarization state is not changed. Accordingly, there is no change in luminance.

For example, when the liquid crystal layer 30 is in the non-applied state, the liquid crystal molecules 31 are aligned substantially perpendicular to the substrate surface of the liquid crystal element. The direction of polarization of polarized light of the linearly polarized light that has entered the liquid crystal layer 30 is identical with a director of the liquid crystal molecules 31, and therefore, the direction of polarization does not change. When a refractive index of the liquid crystal layer 30 in this state is assumed as n1, and a thickness of the liquid crystal layer 30 is assumed as d, an amount of delay of a phase of output light from the liquid crystal element of the phase modulation type is n1d.

Furthermore, for example, when a predetermined voltage is applied to the liquid crystal layer 30, the liquid crystal molecules 31 are aligned substantially parallel to the substrate surface of the liquid crystal element. In this case, the direction of polarization of polarized light of the linearly polarized light that has entered the liquid crystal layer 30 is identical with the director of the liquid crystal molecules 31, and therefore, the direction of polarization does not change. When the liquid crystal molecules 31 are parallel to the substrate surface of the liquid crystal element, refractive index anisotropy of the liquid crystal molecules 31 is maximized. The refractive index of the liquid crystal layer 30 is obtained by subtracting a refractive index no of an ordinary ray from a refractive index ne of an extraordinary ray. When the refractive index of the liquid crystal layer 30 in this state is assumed as n2, and the thickness of the liquid crystal layer 30 is assumed as d, the amount of delay of the phase of the output light from the liquid crystal element of the phase modulation type is n2d.

Back to FIGS. 2 and 3, the liquid crystal display element 1 is described again.

In the liquid crystal display element 1, as described above, the first alignment film and the second alignment film of which the directions of alignment differ by 45° between the effective pixel region 130 and the peripheral region 120 are formed. Thus, the liquid crystal display element 1 operates as the liquid crystal element of the luminance modulation type in the effective pixel region 130, and as the liquid crystal element of the phase modulation type in the peripheral region 120. Accordingly, in the peripheral region 120, even if the entering light that has entered the counter substrate 10 is modulated by the liquid crystal layer 30, the direction of polarization does not change, but only the phase changes. In the peripheral region 120, even if the reflected light of which the direction of polarization (reflection polarization axis) is parallel to the direction of polarization (entry polarization axis) of the entering light reaches the analyzer 41 as the output light L2, the light is shielded by the analyzer 41. That is, it is possible to suppress the unnecessary light without providing the light shielding mask 51 provided for suppression of the unnecessary light as in the liquid crystal display element 101 according to the comparative example illustrated in FIG. 1. Hence, in the liquid crystal display element 1, it is possible to suppress the vignetting of the output light L1 from the effective pixel region 130 while suppressing, by the peripheral driving electrode unit 21B, the degradation in the image quality to be caused by the impurity ions.

It is to be noted that the forgoing description is made by giving an example of the configuration of the reflective liquid crystal display element, but the present technology is also applicable to a transmissive liquid crystal display element.

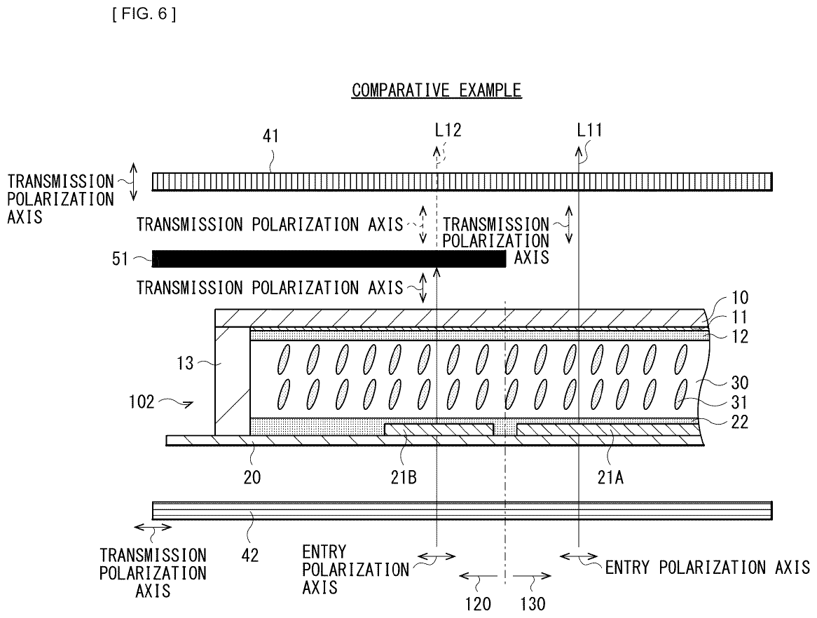

FIG. 6 illustrates an example of across-sectional configuration of a liquid crystal display element 102 according to a second configuration example of the comparative example.

Here, description is given of portions different from the liquid crystal display element 101 according to the comparative example illustrated in FIG. 1. Moreover, description is given here of an example case where the polarizer 42 including a polarizing plate is disposed on the pixel substrate 20 side, and the analyzer 41 is disposed on the counter substrate 10 side. The transmission polarization axis of the polarizer 42 and the transmission polarization axis of the analyzer 41 are orthogonal to each other, and the polarizer 42 and the analyzer 41 are in the crossed Nicol arrangement with each other.

In the liquid crystal display element 102, in the effective pixel region 130, the entering light that has entered the pixel substrate 20 is modulated by the liquid crystal layer 30 and outputted from the counter substrate 10 side. In the liquid crystal display element 102, transmitted light of which the direction of polarization is orthogonal to the direction of polarization (entry polarization axis) of the entering light is outputted as output light L11 through the analyzer 41.

In the liquid crystal display element 102, the alignment film 12 and the alignment film 22 having the same direction of alignment in the effective pixel region 130 and the peripheral region 120 are formed. Thus, in the peripheral region 120 as well, the entering light that has entered the pixel substrate 20 is modulated by the liquid crystal layer 30 and outputted from the counter substrate 10 side. That is, in the liquid crystal display element 102, in the peripheral region 120 as well, the transmitted light of which the direction of polarization is orthogonal to the direction of polarization (entry polarization axis) of the entering light is outputted as output light L12 through the analyzer 41. The output light L12 in the peripheral region 120 becomes the unnecessary light. In this case, it is conceivable to suppress the unnecessary light by providing, for example, the light shielding mask 51 as the mechanical light shielding unit. However, by providing the light shielding mask 51, there is possibility that the vignetting of the light beams occurs in the output light L11 from the effective pixel region 130, resulting in the degradation in the image quality. Accordingly, in the configuration of the liquid crystal display element 102, it is difficult to suppress the vignetting of the output light L11 from the effective pixel region 130 while suppressing, by the peripheral driving electrode unit 21B, the degradation in the image quality to be caused by the impurity ions.

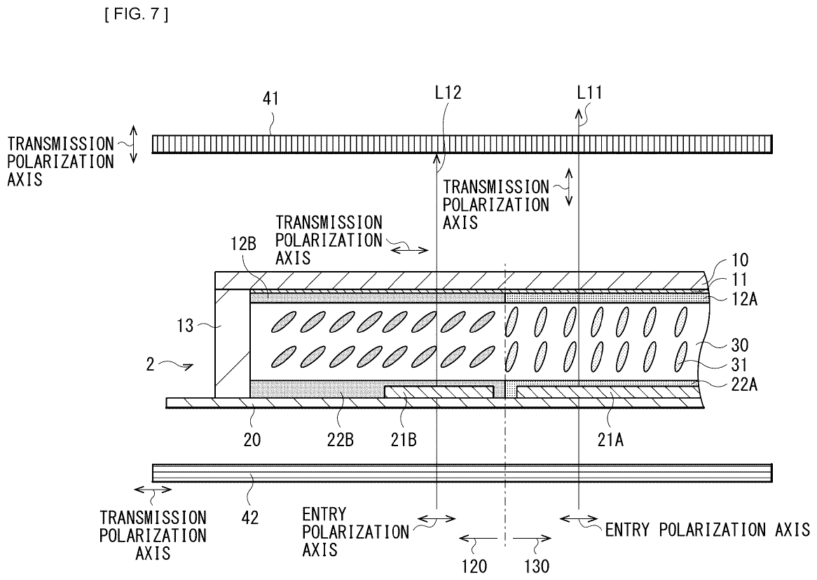

FIG. 7 illustrates an example of across-sectional configuration of a liquid crystal display element 2 according to a second configuration example of the first embodiment. In the following, description is given of portions different from the liquid crystal display element 102 according to the comparative example illustrated in FIG. 6 and the liquid crystal display element 1 illustrated in FIG. 2. Moreover, here, description is made by giving an example case where the polarizer 42 including a polarizing plate is disposed on the pixel substrate 20 side, and the analyzer 41 is disposed on the counter substrate 10 side. The transmission polarization axis of the polarizer 42 and the transmission polarization axis of the analyzer 41 are orthogonal to each other, and the polarizer 42 and the analyzer 41 are in the crossed Nicol arrangement with each other.

In the liquid crystal display element 2, the first alignment film (the alignment film 12A and the alignment film 22A) and the second alignment film (the alignment film 12B and the alignment film 22B) of which the directions of alignment differ by 45° between the effective pixel region 130 and the peripheral region 120 are formed. Thus, the liquid crystal display element 2 operates as the liquid crystal element of the luminance modulation type in the effective pixel region 130, and as the liquid crystal element of the phase modulation type in the peripheral region 120. Accordingly, in the peripheral region 120, even if the entering light that has entered the pixel substrate 20 is modulated by the liquid crystal layer 30, the direction of polarization does not change, but only the phase changes. In the peripheral region 120, even if the transmitted light of which the direction of polarization is parallel to the direction of polarization (entry polarization axis) of the entering light reaches the analyzer 41 as the output light L12, the light is blocked by the analyzer 41. That is, it is possible to suppress the unnecessary light without providing the light shielding mask 51 provided for the suppression of the unnecessary light as in the liquid crystal display element 102 according to the comparative example illustrated in FIG. 6. Hence, in the liquid crystal display element 2, it is possible to suppress the vignetting of the output light L11 from the effective pixel region 130 while suppressing, by the peripheral driving electrode unit 21B, the degradation in the image quality to be caused by the impurity ions.

### 1.2 Modification Examples

### Modification Example 1

FIG. 8 illustrates a configuration example of Modification Example 1 of the liquid crystal display element 1 according to the first embodiment.

In the configuration example illustrated in FIG. 3, the liquid crystal molecules 31 in the peripheral region 120 are configured to be parallel to the horizontal direction in a plan view of the liquid crystal display element 1, but as illustrated in FIG. 8, the liquid crystal molecules 31 in the peripheral region 120 may be configured to be parallel to the vertical direction in the plan view. In this case as well, the direction of alignment of the second alignment film (the alignment film 12B and the alignment film 22B)(second angle of direction) is configured to be a direction that differs by 45° from the direction of alignment of the first alignment film (the alignment film 12A and the alignment film 22A) (first angle of direction).

### Modification Example 2

FIG. 9 illustrates a configuration example of Modification Example 2 of the liquid crystal display element 1 according to the first embodiment.

In contrast to the configuration of the liquid crystal display element 1 illustrated in FIG. 2, the peripheral driving electrode unit 21B may be configured to include multiple electrodes. In this case, it is possible to generate the lateral electric field by applying the periodically switching driving voltage of the rectangular shape to between adjacent electrodes of the multiple electrodes, to move the impurity ions to the peripheral region 120. In the case of the method in which the driving voltage of the rectangular shape is also applied to the pixel electrode unit 21A, the frequency of the driving voltage to be applied to the peripheral driving electrode unit 21B may be set higher than the frequency of the driving voltage to be applied to the pixel electrode unit 21A. Moreover, the magnitude (amplitude) of the driving voltage to be applied to the peripheral driving electrode unit 21B may be set larger than the magnitude (amplitude) of the driving voltage to be applied to the pixel electrode unit 21A.

### 1.3 Application Examples to Display Apparatus

FIG. 10 illustrates a first configuration example of a display apparatus according to the first embodiment. FIG. 10 illustrates, as the display apparatus, a configuration example of a projection display apparatus (projector) using a reflective liquid crystal display element. As the reflective liquid crystal display element, for example, the liquid crystal display element 1 illustrated in FIG. 2 may be used.

The display apparatus illustrated in FIG. 10 includes a light source 60, an illumination optical system 61, a PBS (polarizing beam splitter) 62, the liquid crystal display element 1, and a projection optical system 70.

The light source 60 is, for example, a laser light source. The illumination optical system 61 includes a fly's eye lens, a collimating lens, and the like. The illumination optical system 61 outputs light from the light source 60 as illumination light toward the PBS 62. The PBS 62 reflects, for example, S-polarized light and transmits P-polarized light. The PBS 62 acts as a polarizer for the illumination light from the illumination optical system 61. The PBS 62 outputs S-polarized light toward the liquid crystal display element 1. The liquid crystal display element 1 modulates S-polarized light and outputs P-polarized light toward the PBS 62. The PBS 62 acts as an analyzer for the output light from the liquid crystal display element 1. The modulated light from the liquid crystal display element 1 enters the projection optical system 70 through the PBS 62. The projection optical system 70 is, for example, a projection lens. The projection optical system 70 projects the modulated light from the liquid crystal display element 1 as an image onto a screen 71.

FIG. 11 illustrates a second configuration example of the display apparatus according to the first embodiment.

FIG. 11 illustrates, as the display apparatus, a configuration example of a projection display apparatus (projector) using a transmissive liquid crystal display element. As the transmissive liquid crystal display element, for example, the liquid crystal display element 2 illustrated in FIG. 7 may be used.

The display apparatus illustrated in FIG. 11 includes the light source 60, the illumination optical system 61, the polarizer 42, the liquid crystal display element 2, the analyzer 41, and the projection optical system 70. The transmission polarization axis of the polarizer 42 and the transmission polarization axis of the analyzer 41 are orthogonal to each other, and the polarizer 42 and the analyzer 41 are in the crossed Nicol arrangement with each other.

The light source 60 is, for example, a laser light source. The illumination optical system 61 includes a fly's eye lens, a collimating lens, and the like. The illumination optical system 61 outputs the light from the light source 60 as the illumination light toward the liquid crystal display element 2 through the analyzer 41. The liquid crystal display element 2 modulates the entering light and outputs the modulated light toward the analyzer 41. The modulated light from the liquid crystal display element 2 enters the projection optical system 70 through the analyzer 41. The projection optical system 70 is, for example, a projection lens. The projection optical system 70 projects the modulated light from the liquid crystal display element 2 as an image onto the screen 71.

### 1.4 Effects

As described above, according to the liquid crystal display element and the display apparatus of the first embodiment, the peripheral driving electrode unit 21B is formed in the peripheral region 120 of the effective pixel region 130, and the second alignment film (the alignment film 12B and the alignment film 22B) is formed in the peripheral region 120. The second alignment film (the alignment film 12B and the alignment film 22B) has the angle of direction that differs by 45° from that of the first alignment film (the alignment film 12A and the alignment film 22A) formed in the effective pixel region 130. Hence, it is possible to suppress the degradation in the image quality and the generation of the unnecessary light.

It is to be noted that the effects described in the present specification are merely illustrative and not limitative, and there may be other effects. The same applies to the effects of other embodiments in the following.

### <2. Second Embodiment (Effective Pixel Region is Liquid Crystal Element of Phase Modulation Type)

Next, a liquid crystal display element and a display apparatus according to a second embodiment of the present disclosure are described. It is to be noted that, in the following, substantially the same parts as the constituent elements of the liquid crystal display element and the display apparatus according to the first embodiment described above are denoted by the same reference characters, and description thereof is omitted as appropriate.

FIG. 12 illustrates a configuration example of a liquid crystal display element 102A and a display apparatus according to a comparative example.

The display apparatus illustrated in FIG. 12 includes a light source 80, an illumination optical system 81, the liquid crystal display element 102A, a light shielding mask 82, and a projection optical system 90.

The liquid crystal display element 102A according to the comparative example has an effective pixel region 130A and a peripheral region 120A, and the entirety including the effective pixel region 130A and the peripheral region 120A is configured as the liquid crystal element of the phase modulation type. In the effective pixel region 130A, the counter electrode unit 11 and the pixel electrode unit 21A are provided, as with the liquid crystal display element according to the comparative example of the first embodiment. In the peripheral region 120A, the counter electrode unit 11 and the peripheral driving electrode unit 21B are provided, as with the liquid crystal display element according to the comparative example of the first embodiment.

The light source 80 is, for example, a laser light source. The illumination optical system 81 includes a fly's eye lens, a collimating lens, and the like. The illumination optical system 81 outputs light from the light source 80 as the illumination light toward the liquid crystal display element 102A. The liquid crystal display element 102A phase-modulates the entering light and outputs the resultant light toward the projection optical system 90. The projection optical system 90 is, for example, a projection lens. The projection optical system 90 projects the modulated light from the liquid crystal display element 102A as an image onto the screen 71.

Here, in the liquid crystal display element 102A, as with the liquid crystal display element according to the comparative example of the first embodiment, an alignment film having the same direction of alignment in the effective pixel region 130A and the peripheral region 120A is formed. Accordingly, in the peripheral region 120A as well, the light is phase-modulated and the resultant light is outputted. The output light in the peripheral region 120A becomes the unnecessary light. In this case, it is conceivable to suppress the unnecessary light by providing, for example, the light shielding mask 82 as the mechanical light shielding unit. However, providing the light shielding mask 82 causes possibility of the vignetting of the light beams in the output light from the effective pixel region 130A, resulting in the degradation in the image quality. Accordingly, in the configuration of the liquid crystal display element 102A, it is difficult to suppress the vignetting of the output light from the effective pixel region 130A while suppressing, by the peripheral driving electrode unit 21B, the degradation in the image quality caused by the impurity ions.

FIG. 13 illustrates a configuration example of a liquid crystal display element 2A and a display apparatus according to a second embodiment.

In the following, description is given of portions different from the liquid crystal display element 102A and the display apparatus according to the comparative example illustrated in FIG. 12.

The display apparatus illustrated in FIG. 13 includes the light source 80, the illumination optical system 81, the liquid crystal display element 2A, an analyzer 83, and the projection optical system 90.

In the liquid crystal display element 2A, the first alignment film and the second alignment film of which the directions of alignment differ by 45° between the effective pixel region 130A and the peripheral region 120A are formed. Thus, the liquid crystal display element 2A operates as the liquid crystal element of the phase modulation type in the effective pixel region 130A, and as the liquid crystal element of the luminance modulation type in the peripheral region 120A. In the liquid crystal display element 2A, the direction of alignment (first angle of direction) of the first alignment film formed in the effective pixel region 130A is parallel (0°) to the direction of polarization of the entering light. The direction of alignment (second angle of direction) of the second alignment film formed in the peripheral region 120A is a direction inclined by 45°. Accordingly, in the liquid crystal display element 2A, in the peripheral region 120A, the direction of polarization of the entering light is rotated by 90°. Even if the output light from the peripheral region 120A reaches the analyzer 83, the light is blocked by the analyzer 83. The transmission polarization axis of the analyzer 83 is in the same direction as the output light from the effective pixel region 130A of the liquid crystal display element 2A, and the output light from the effective pixel region 130A passes through the analyzer 83. That is, in the liquid crystal display element 2A, it is possible to suppress the unnecessary light without providing the light shielding mask 82 provided for the suppression of the unnecessary light as in the liquid crystal display element 102A according to the comparative example illustrated in FIG. 12. Hence, in the liquid crystal display element 2A, it is possible to suppress the vignetting of the output light L11 from the effective pixel region 130A while suppressing, by the peripheral driving electrode unit 21B, the degradation in the image quality to be caused by the impurity ions.

Other configurations, operation, and effects may be substantially similar to those of the liquid crystal display element and the display apparatus according to the first embodiment described above.

### 3. Other Embodiments

The technology according to the present disclosure is not limited to the description of the embodiments described above, but may be modified in a variety of ways.

For example, the present technology may have the following configurations.

According to the present technology having the following configurations, the peripheral driving electrode is formed in the peripheral region of the effective pixel regions. In the peripheral region, the second alignment film is formed. The second alignment film differs in the angle of direction by 45° from the first alignment film formed in the effective pixel region. Hence, it is possible to suppress the degradation in the image quality and the generation of the unnecessary light.

(1)

A liquid crystal display element including:
a first substrate;
a second substrate disposed opposite to the first substrate, with a liquid crystal layer, including multiple liquid crystal molecules, interposed between the first substrate and the second substrate;
a first electrode unit formed in an effective pixel region in the first substrate, and a peripheral region of the effective pixel region in the first substrate;
a second electrode unit including a pixel electrode unit and a peripheral driving electrode unit, the pixel electrode unit being formed in the effective pixel region in the second substrate, and the peripheral driving electrode unit being formed in the peripheral region in the second substrate;
a first alignment film formed in the effective pixel region in each of the first substrate and the second substrate, with a direction of alignment taking a first angle of direction; and
a second alignment film formed in the peripheral region in each of the first substrate and the second substrate, with a direction of alignment taking a second angle of direction, the second angle of direction differing by 45° from the first angle of direction.

(2)

The liquid crystal display element according to (1), in which
the first angle of direction is a direction inclined by 45° with respect to a direction of polarization of entering light, and
the second angle of direction is parallel or perpendicular to the direction of polarization of the entering light.

(3)

The liquid crystal display element according to (2), in which
the liquid crystal display element is configured to operate as a liquid crystal element of a luminance modulation type in the effective pixel region, and as a liquid crystal element of a phase modulation type in the peripheral region.

(4)

The liquid crystal display element according to (1), in which
the first angle of direction is parallel to a direction of polarization of entering light, and
the second angle of direction is a direction inclined by 45° with respect to the direction of polarization of the entering light.
(5)

The liquid crystal display element according to (4), in which
the liquid crystal display element is configured to operate as a liquid crystal element of a phase modulation type in the effective pixel region, and as a liquid crystal element of a luminance modulation type in the peripheral region.
(6)

The liquid crystal display element according to any one of (1) to (5), in which
the peripheral driving electrode unit includes multiple electrodes.
(7)

The liquid crystal display element according to (6), in which
a periodically switching driving voltage is applied to between adjacent electrodes of the multiple electrodes of the peripheral driving electrode unit.
(8)

A display apparatus provided with
a liquid crystal display element and
a projection optical system that projects an image generated by the liquid crystal display element,
the liquid crystal display element including:
a first substrate;
a second substrate disposed opposite to the first substrate, with a liquid crystal layer, including multiple liquid crystal molecules, interposed between the first substrate and the second substrate;
a first electrode unit formed in an effective pixel region in the first substrate, and a peripheral region of the effective pixel region in the first substrate;
a second electrode unit including a pixel electrode unit and a peripheral driving electrode unit, the pixel electrode unit being formed in the effective pixel region in the second substrate, and the peripheral driving electrode unit being formed in the peripheral region in the second substrate;
a first alignment film formed in the effective pixel region in each of the first substrate and the second substrate, with a direction of alignment taking a first angle of direction; and
a second alignment film formed in the peripheral region in each of the first substrate and the second substrate, with a direction of alignment taking a second angle of direction, the second angle of direction differing by 45° from the first angle of direction.

(9)

The display apparatus according to (8), further including an analyzer disposed on light output side from the liquid crystal display element.

This application claims the priority on the basis of Japanese Patent Application No. 2021-205013 filed on Dec. 17, 2021 with Japan Patent Office, the entire contents of which are incorporated in this application by reference.

It should be understood by those skilled in the art that various modifications, combinations, sub-combinations, and alterations may occur depending on design requirements and other factors insofar as they are within the scope of the appended claims or the equivalents thereof.

1. A liquid crystal display element comprising:
a first substrate;
a second substrate disposed opposite to the first substrate, with a liquid crystal layer, including multiple liquid crystal molecules, interposed between the first substrate and the second substrate;
a first electrode unit formed in an effective pixel region in the first substrate, and a peripheral region of the effective pixel region in the first substrate;
a second electrode unit including a pixel electrode unit and a peripheral driving electrode unit, the pixel electrode unit being formed in the effective pixel region in the second substrate, and the peripheral driving electrode unit being formed in the peripheral region in the second substrate;
a first alignment film formed in the effective pixel region in each of the first substrate and the second substrate, with a direction of alignment taking a first angle of direction; and
a second alignment film formed in the peripheral region in each of the first substrate and the second substrate, with a direction of alignment taking a second angle of direction, the second angle of direction differing by 45° from the first angle of direction.

2. The liquid crystal display element according to claim 1, wherein
the first angle of direction is a direction inclined by 45° with respect to a direction of polarization of entering light, and
the second angle of direction is parallel or perpendicular to the direction of polarization of the entering light.

3. The liquid crystal display element according to claim 2, wherein
the liquid crystal display element is configured to operate as a liquid crystal element of a luminance modulation type in the effective pixel region, and as a liquid crystal element of a phase modulation type in the peripheral region.

4. The liquid crystal display element according to claim 1, wherein
the first angle of direction is parallel to a direction of polarization of entering light, and
the second angle of direction is a direction inclined by 45° with respect to the direction of polarization of the entering light.

5. The liquid crystal display element according to claim 4, wherein
the liquid crystal display element is configured to operate as a liquid crystal element of a phase modulation type in the effective pixel region, and as a liquid crystal element of a luminance modulation type in the peripheral region.

6. The liquid crystal display element according to claim 1, wherein
the peripheral driving electrode unit includes multiple electrodes.

7. The liquid crystal display element according to claim 6, wherein
a periodically switching driving voltage is applied to between adjacent electrodes of the multiple electrodes of the peripheral driving electrode unit.

8. A display apparatus provided with
a liquid crystal display element and
a projection optical system that projects an image generated by the liquid crystal display element,
the liquid crystal display element comprising:
a first substrate:
a second substrate disposed opposite to the first substrate, with a liquid crystal layer, including multiple liquid crystal molecules, interposed between the first substrate and the second substrate:
a first electrode unit formed in an effective pixel region in the first substrate, and a peripheral region of the effective pixel region in the first substrate:
a second electrode unit including a pixel electrode unit and a peripheral driving electrode unit, the pixel electrode unit being formed in the effective pixel region in the second substrate, and the peripheral driving electrode unit being formed in the peripheral region in the second substrate;
a first alignment film formed in the effective pixel region in each of the first substrate and the second substrate, with a direction of alignment taking a first angle of direction; and
a second alignment film formed in the peripheral region in each of the first substrate and the second substrate, with a direction of alignment taking a second angle of direction, the second angle of direction differing by 45° from the first angle of direction.

9. The display apparatus according to claim 8, further comprising an analyzer disposed on light output side from the liquid crystal display element.
